(19) United States
(12) Patent Application Publication
(10) Pub. No.: US 2013/0293506 A1
(43) Pub. Date: Nov. 7, 2013

(54) Capacitive Switch Automatic Adjustment

(71) Applicants: Tarek El-Khaled, Dearborn Heights, MI (US); Hiroki Inoue, West Bloomfield, MI (US); Deepan Shrivastava, Troy, MI (US)

(72) Inventors: Tarek El-Khaled, Dearborn Heights, MI (US); Hiroki Inoue, West Bloomfield, MI (US); Deepan Shrivastava, Troy, MI (US)

(73) Assignee: DENSO INTERNATIONAL AMERICA, INC., Southfield, MI (US)

(21) Appl. No.: 13/460,881

(22) Filed: May 1, 2012

(51) Int. Cl. G06F 3/041

(52) U.S. Cl. 345/174

(57) ABSTRACT

A method for adjusting input sensitivity of a touchscreen. The method includes: providing input sensitivity of the touchscreen at a base level; increasing input sensitivity of the touchscreen above the base level in response to detection of at least one predetermined condition; and returning input sensitivity of the touchscreen to the base level when atmospheric temperature proximate to the touchscreen is equal to or greater than a first target temperature

### FIELD

The present disclosure relates to automatic adjustment of a capacitive switch, and automatic sensitivity adjustment of a touchscreen including a capacitive switch.

### BACKGROUND

This section provides background information related to the present disclosure, which is not necessarily prior art.

Touchscreens are included with a variety of user interfaces to facilitate interaction between a user and a machine. For example, an automobile can include a touchscreen for selecting and operating various vehicle systems, such as a navigation system, climate control system, audio system, and communication system.

Touchscreens are often set by a manufacturer or seller at a predetermined sensitivity level by a manufacturer or seller that is optimized to detect contact between a user's bare fingers and the touchscreen. As a result, if a user is wearing gloves, for example, the touchscreen may be less responsive. Applicants have addressed this issue with a device and method for automatically adjusting touchscreen sensitivity, such as to increase sensitivity from a standard sensitivity to a heightened sensitivity when it is anticipated that the user may be wearing gloves, and to return to the standard sensitivity when it is anticipated that the user will no longer be wearing gloves.

### SUMMARY

This section provides a general summary of the disclosure, and is not a comprehensive disclosure of its full scope or all of its features.

The present teachings provide for a method for adjusting input sensitivity of a touchscreen. The method includes: providing input sensitivity of the touchscreen at a base level; increasing input sensitivity of the touchscreen above the base level in response to detection of at least one predetermined condition; and returning input sensitivity of the touchscreen to the base level when atmospheric temperature proximate to the touchscreen is equal to or greater than a first target temperature.

The present teachings also provide for a method for adjusting input sensitivity of a touchscreen including the following: providing input sensitivity of the touchscreen at a base level; increasing input sensitivity of the touchscreen above the base level in response to detection of at least one predetermined condition; maintaining the input sensitivity of the touchscreen above the base level for a predetermined amount of time measured by a timer; comparing atmospheric temperature proximate to the touchscreen to a first target temperature after expiration of the predetermined amount of time; returning input sensitivity of the touchscreen to the base level when atmospheric temperature proximate to the touchscreen is equal to or greater than the first target temperature; and maintaining input sensitivity of the touchscreen above the base level when atmospheric temperature proximate to the touchscreen is below the first target temperature

The present teachings also provide for a vehicle navigation touchscreen assembly. The assembly includes a touchscreen and a controller. The touchscreen is configured to receive input commands from a user of a vehicle navigation device. The controller is in communication with the touchscreen and is configured to adjust input sensitivity of the touchscreen. The controller is also in communication with a vehicle cabin temperature input resource and an external temperature input resource. The vehicle cabin temperature input resource is configured to measure temperature inside a vehicle cabin. The external temperature input resource is configured to measure temperature outside the vehicle cabin. The controller is configured to increase input sensitivity of the touchscreen above a base level in response to occurrence of at least one predetermined condition. The controller is further configured to set input sensitivity of the touchscreen at the base level when temperature in the vehicle cabin is greater than or equal to a first target temperature.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations. The drawings are not intended to limit the scope of the present disclosure.

FIG. 1 is a block diagram including a touchscreen, a controller, a vehicle cabin temperature input resource, an external temperature input resource, and communication therebetween according to the present teachings;

FIG. 2 is a flowchart of a method for adjusting sensitivity of a touchscreen according to the present teachings;

FIG. 3 is a flowchart of a method for obtaining seasonal information according to the present teachings;

FIG. 4 is a flowchart of a method for setting a temperature input resource according to the present teachings;

FIG. 5 is a flowchart of a method for comparing temperature measured by a set temperature input resource to a target temperature according to the present teachings;

FIG. 6 is flowchart of another method for adjusting sensitivity of a touchscreen according to the present teachings; and

FIG. 7 is a flowchart of yet an additional method for adjusting sensitivity of a touchscreen according to the present teachings.

Corresponding reference numerals indicate corresponding parts throughout the several views of the drawings.

### DETAILED DESCRIPTION

Example embodiments will now be described more fully with reference to the accompanying drawings.

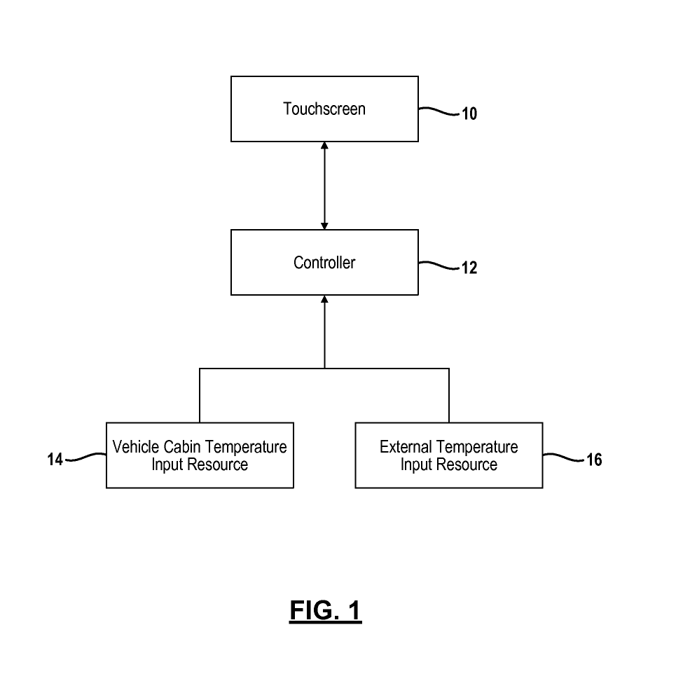

With initial reference to FIG. 1, a vehicle navigation touchscreen assembly according to the present teachings includes a touchscreen 10 in communication with a controller 12. The touchscreen 10 can be any suitable touchscreen user interface configured to receive command inputs from a user when the user touches the touchscreen with his or her finger. The touchscreen can detect touch inputs from the user in any suitable manner, such as with a plurality of capacitance touch switches. The controller 12 can be any suitable device for controlling sensitivity of the touchscreen 10 and can include, for example, a central processing unit.

The touchscreen 10 and the controller 12 can be configured for use in any suitable vehicle, such as an automobile, boat, tank, all-terrain recreational vehicle, airplane, or helicopter. While the touchscreen 10 and the controller 12 are described herein as being used in a vehicle, the present teachings are applicable to any suitable electronic device including a touchscreen. For example, the touchscreen 10 and controller 12 can be included with an automated teller machine, a vending machine, a parking fee collection device, a toll collection device, or an admission ticket distribution device.

The controller 12 is configured to receive inputs from a vehicle cabin temperature input resource 14 and an external temperature input resource 16. The cabin temperature input resource 14 can include any suitable device, system, or method for measuring temperature inside a vehicle passenger cabin, such as a thermometer included in a vehicle climate control system or heating ventilation and air conditioning system (HVAC). The external temperature input resource 16 can be any suitable device, system, or method for measuring temperature external to a vehicle passenger cabin. For example, the external temperature input resource 16 can include a thermometer mounted to an exterior of a vehicle, a thermometer of a meteorological service, such as a satellite weather service. Temperature measurements performed by the meteorological service can be transmitted by satellite to a receiver associated with the controller 12 in order to convey external temperature to the controller 12. Temperature measurements performed by the meteorological service can also, for example, be transmitted to a user's personal electronic data device, such as a smartphone, which can then convey the temperature information to the controller 12, such as through a Bluetooth connection.

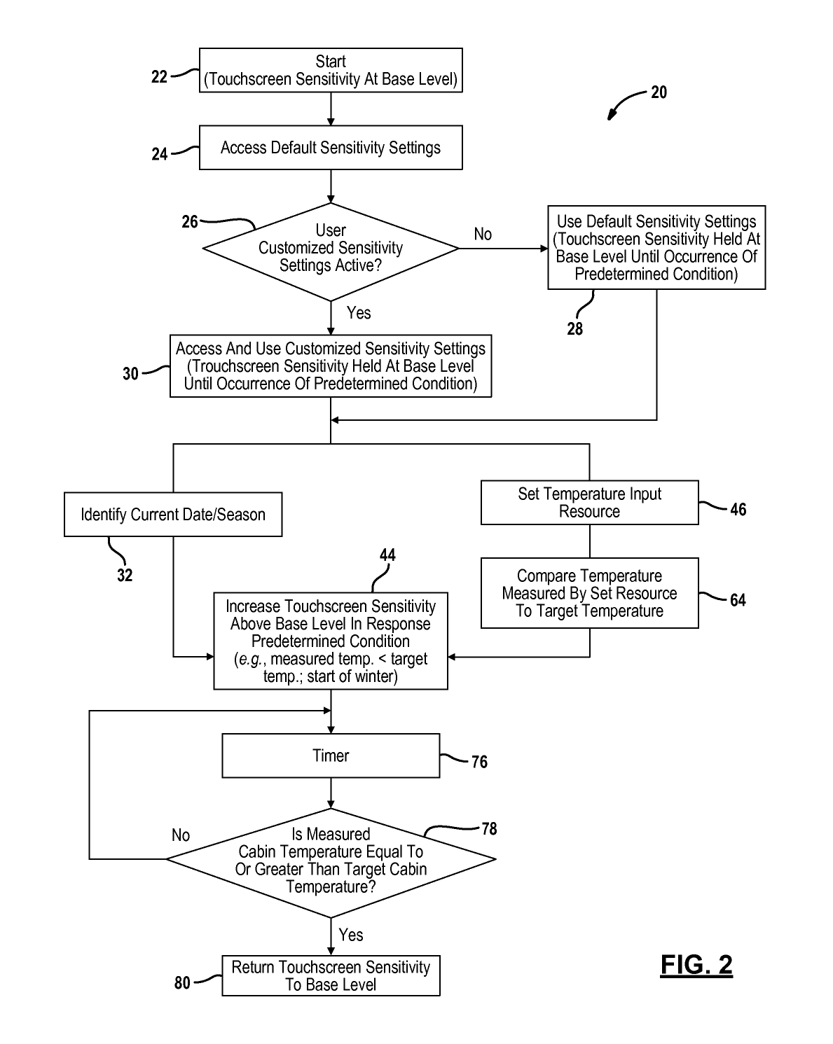

With additional reference to FIG. 2, a method for adjusting an input sensitivity of the touchscreen 10 according to the present teachings is generally illustrated at reference number 20. With initial reference to block 22, the touchscreen 10 includes a base level sensitivity. The base level sensitivity generally corresponds to a sensitivity level at which the touchscreen 10 can identify inputs provided by a user when the user touches the touchscreen 10 with his or her bare fingers (i.e., without wearing gloves). The base level sensitivity can be determined and set by a manufacturer of the touchscreen 10 or a seller of a vehicle that includes the touchscreen 10.

With reference to block 24, the controller 12 accesses default sensitivity settings for the touchscreen 10. The default sensitivity settings can be accessed from any suitable source, such as memory accessible to the controller 12, or from any suitable device accessible to the controller 12. The default sensitivity settings can include, for example, one or more of the following: a sensitivity control setting, which can be set to automatic or off; a temperature input resource setting set to satellite weather, connected services (such as a smart phone in receipt of weather information from a meteorological service), or HVAC cabin temperature input; a target interior cabin temperature setting at and above which a user is unlikely to be wearing gloves; a target exterior temperature setting at and above which a user is unlikely to be wearing gloves; a seasonal compensation setting set to on or off; and a seasonal compensation setting including a start date and end date for a seasonal period during which a user is likely to be wearing gloves.

The default sensitivity settings can be set in any manner deemed appropriate by the manufacture and/or the seller of the touchscreen 10, such as to reflect the results of surveys taken of potential and/or current users. For example, if survey results show that increasing sensitivity of the touchscreen 10 above the base level in cooler conditions when the user is likely to be wearing gloves would be benefit the average user, then the sensitivity control setting can be set to automatic. If the average user is likely to have access to satellite weather, then the temperature input resource setting can be set to satellite weather. If the average user is likely to be wearing gloves both inside and outside the vehicle when the temperature is below 65° F., then the target interior and exterior temperature can be set to 65° F. If the user lives in an area where he or she is likely to be wearing gloves during a particular time of year, then the seasonal compensation setting can be set to “on” such that sensitivity of the touchscreen 10 is increased above the base level from, for example, October 15^{th} through April 15^{th} for touchscreens sold in the Northern Hemisphere.

The controller 12 is also configured to permit a user to customize each of the default sensitivity settings to accommodate the user's own preferences and the environmental conditions in which the user does the majority of his or her driving. For example, users who live in the northern half of the United States may set a wider date range for the seasonal schedule than customers who live further south. Users who live in traditionally warm climates may increase the target temperatures because they are conditioned to warmer temperatures, and may thus wear gloves at warmer temperatures than a user accustomed to colder temperatures would.

With reference to block 26, if the user has not customized the default sensitivity settings, or the user's customized settings have not been activated by the user, then the controller 12 will proceed to block 28 and operate the touchscreen 10 based on the default sensitivity settings. If the user has customized and activated the sensitivity settings, then the controller 12 will access the user customized sensitivity settings at block 30 and control sensitivity of the touchscreen 10 according to the user customized sensitivity settings.

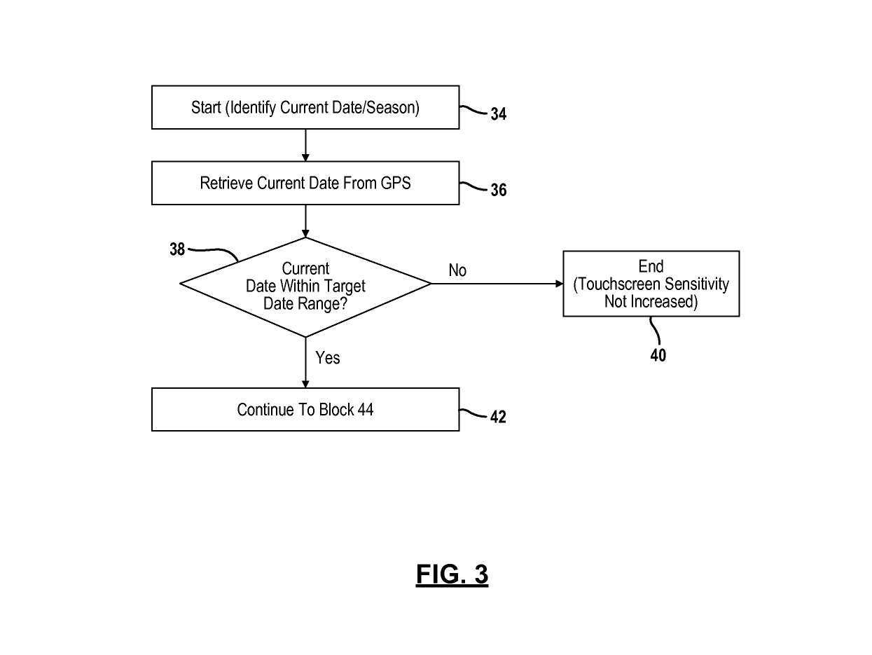

With reference to block 32, if seasonal compensation is activated by the user or set at active in the default sensitivity settings, the controller 12 will operate to identify the current date, and thus the season as well, at block 34 of FIG. 3. At block 36 of FIG. 3, the controller 12 retrieves the current date from a GPS system. Alternatively, the controller 12 can obtain the current date from any suitable clock that is either internal or external to the controller 12. At block 38, the controller 12 determines whether the current date is within the default target date range or the target date range set by the user. If the current date does fall within the target date range, then at block 40 the sensitivity of the touchscreen is not increased, but rather remains at the base level. If the current date does fall within the target date range, then at block 42 the controller 12 proceeds to increase sensitivity of the touchscreen 10 above the base level at block 44. Sensitivity of the touchscreen 10 is increased to any suitable level whereby inputs to the touchscreen 10 by a user wearing gloves can be accurately detected by the touchscreen 10 and the controller 12.

The controller 12 can also increase sensitivity of the touchscreen 10 based on temperature internal and/or external to the passenger cabin. Internal temperature of the passenger cabin can be measured by the vehicle cabin temperature input resource 14. Temperature external to the passenger cabin can be measured by the external temperature input resource 16. When temperature is used as an input to the controller 12, the controller 12 operates at block 46 to set the temperature input resource.

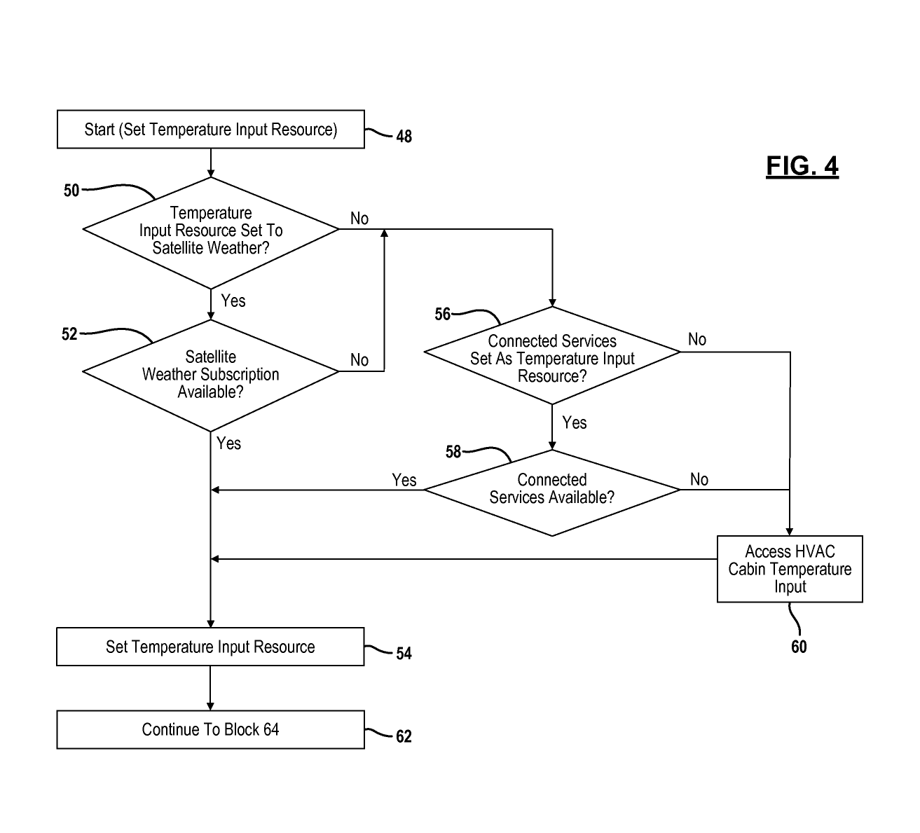

With additional reference to FIG. 4, setting of the temperature input resource by the controller 12 is further described beginning at block 48. At block 50, the controller 12 determines whether the external temperature input resource 16 was set to satellite weather by the user (if the user customize sensitivity settings are active) or by the manufacturer/seller (if the default sensitivity settings are active). If satellite weather was selected, then at block 52 the controller 12 determines whether or not satellite weather is available to the user. For example, the controller 12 determines if a satellite weather signal is available to the user, and if it is, whether the user's satellite weather subscription is active. If satellite weather is available and the user's subscription is active, then at block 54 the controller 12 sets the temperature input resource to satellite weather.

If at block 50 the controller 12 determines that satellite weather was not selected, or determines at block 52 that no satellite weather subscription is available, then at block 56 the controller 12 determines whether connected services have been set as the external temperature input resource 16 by either the user or the manufacturer/seller of the touchscreen 10. As discussed above, connected services can include any suitable device configured to receive or measure temperature external to the vehicle cabin housing the touchscreen 10. For example, connected services can include a portable electronic device, such as a user's cellular smartphone configured to connect to the controller 12 by Bluetooth connection. With respect to a smartphone, current temperature in the city where the vehicle is located can be transmitted to the controller 12 by way of the smartphone to provide the controller 12 with current external temperature. Connected services can also include a thermometer mounted at an external surface of the vehicle and configured to input measured temperature to the controller 12. Yet another connected service that may be used is a wireless internet connection configured to provide external temperature readings to the controller 12.

If at block 56 the controller 12 determines that one or more connected services have been set as the external temperature input resource 16, then at block 58 the controller 12 determines whether the connected service or service are available in order of preference. For example, if use of a smartphone as a connected service is preferred, the controller 12 will first determine whether a Bluetooth connection with a smartphone is available. If a smartphone is available, then the controller 12 proceeds to block 54 and sets the temperature input resource to the smartphone. If more than one connected services is available, the user may also be given the option of selecting a connected service of his or her choice.

If at block 56 the controller 12 determines that connected services have not been selected for use as the external temperature input resource 16, or determines at block 58 that no connected services are available, then the controller 12 proceeds to block 60. At block 60, the controller 12 relies on the vehicle cabin temperature input resource 14 as a substitute for the unavailable external temperature input resource 16. For example, the vehicle cabin temperature input resource 14 can include a thermometer of the vehicle HVAC system. At block 54 the controller 12 then sets the temperature input resource to the thermometer of the vehicle HVAC system. With the temperature input resource set, at block 62 the controller 12 continues to block 64 of FIG. 2.

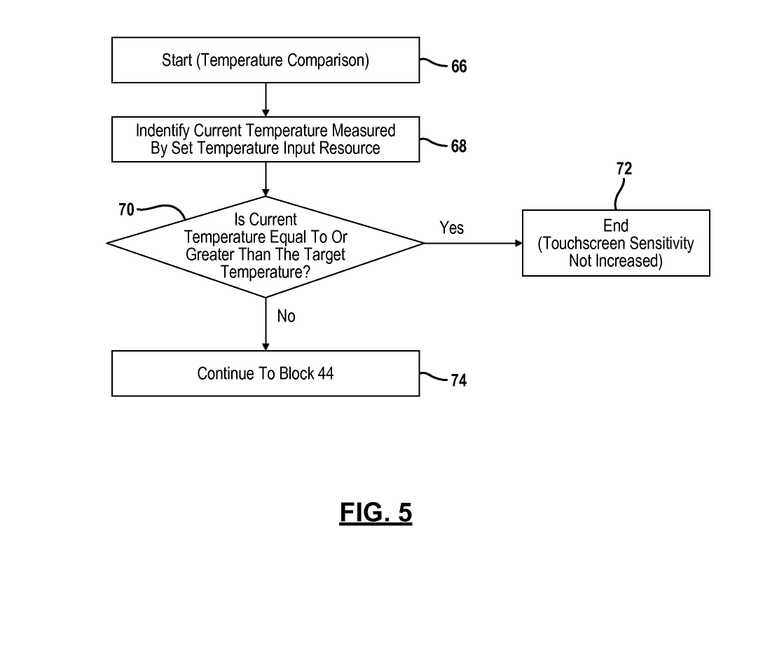

At block 64, the controller 12 compares the temperature measured by the set temperature resource to the default target temperature or the user customized default temperature. If the input resource was set to the cabin temperature input resource 14, then the target interior cabin temperature setting is used. If the input resource was set to the external temperature input resource 16, then the target exterior temperature setting is used. With additional reference to FIG. 5, the controller 12 initiates the temperature comparison at block 66 and at block 68 the controller 12 identifies the current temperature measured by the set temperature input resource. At block 70, the controller 12 determines whether the current temperature is equal to or greater than the target temperature. If the current temperature is equal to or greater than the target temperature, then the controller 12 proceeds to block 72 and does not increase sensitivity of the touchscreen 10. If the current temperature is less than the target temperature, then the controller 12 proceeds to block 74, from which the controller 12 is directed to block 44 of FIG. 2. As described above, at block 44 the controller 12 increases sensitivity of the touchscreen above the base level.

From block 44, the controller 12 proceeds to block 76. At block 76, the controller 12 maintains sensitivity of the touchscreen 10 above the base level for a predetermined period of time measured by a timer. The predetermined period of time is equal to an estimated amount of time needed for the cabin temperature to rise to a level equal to or greater than the target cabin temperature. The cabin temperature is measured by the vehicle cabin temperature input resource 14.

Thus, if the cabin temperature is ten degrees less than the target cabin temperature, for example, the timer will be set to a longer time period than if the cabin temperature is five degrees less than the target cabin temperature. After expiration of the predetermined period of time, the controller 12 proceeds to block 78 and compares atmospheric temperature proximate to the touchscreen 10 with a target temperature. When the touchscreen 10 is included in a vehicle for example, at block 78 the controller compares cabin temperature measured by the cabin temperature input resource 14 with the target cabin temperature. If the measured cabin temperature is equal to or greater than the target cabin temperature, then the controller 12 proceeds to block 80 and returns touchscreen sensitivity to the base level. This is because when the cabin temperature is equal to or greater than the target cabin temperature the user will likely not be wearing gloves. If the cabin temperature is less than the target cabin temperature, then the controller 12 returns to block 76 and again maintains touchscreen sensitivity above the base level for the predetermined period of time.

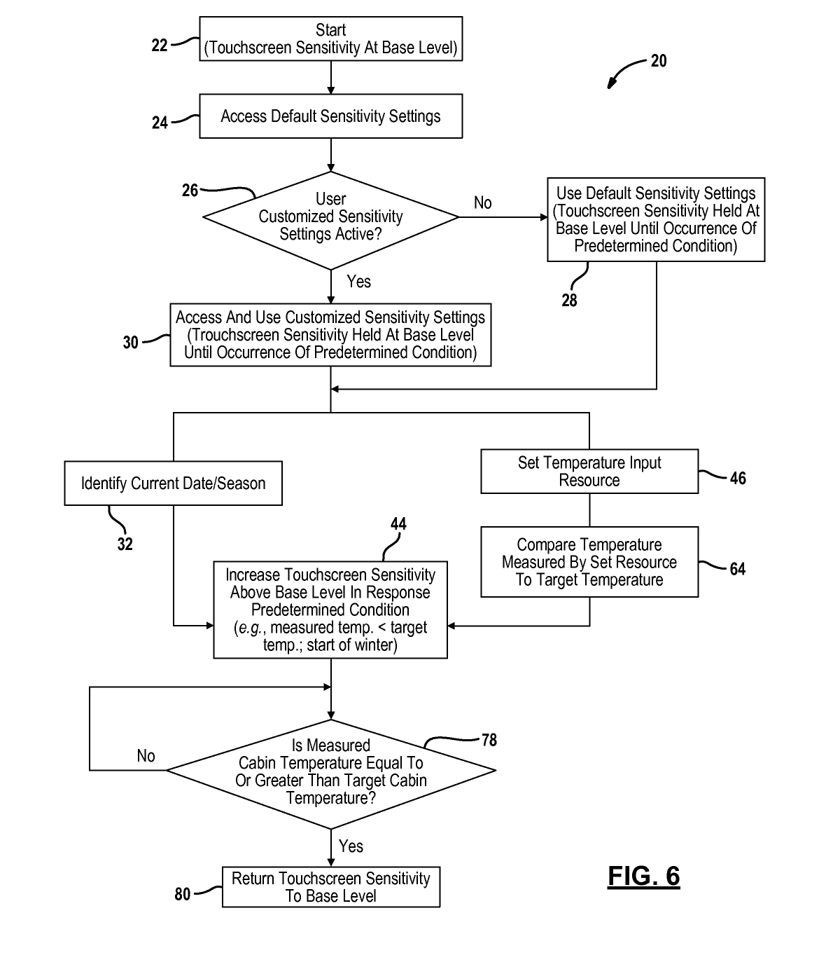

With additional reference to FIG. 6, the method 20 can be modified to not include the timer at block 76. Thus, after the controller 12 increases touchscreen sensitivity above the base level at block 44, the controller 12 immediately proceeds to block 78 where the controller 12 determines whether the cabin temperature is equal to or greater than the target cabin temperature. If the controller 12 determines that the cabin temperature is less than the target cabin temperature, then the controller 12 will continuously monitor the cabin temperature and maintain the touchscreen sensitivity above the base level until the measured cabin temperature is equal to or greater than the target cabin temperature. Once the cabin temperature rises such that it is equal to or greater than the target cabin temperature, the controller 12 proceeds to block 80 and returns touchscreen sensitivity to the base level.

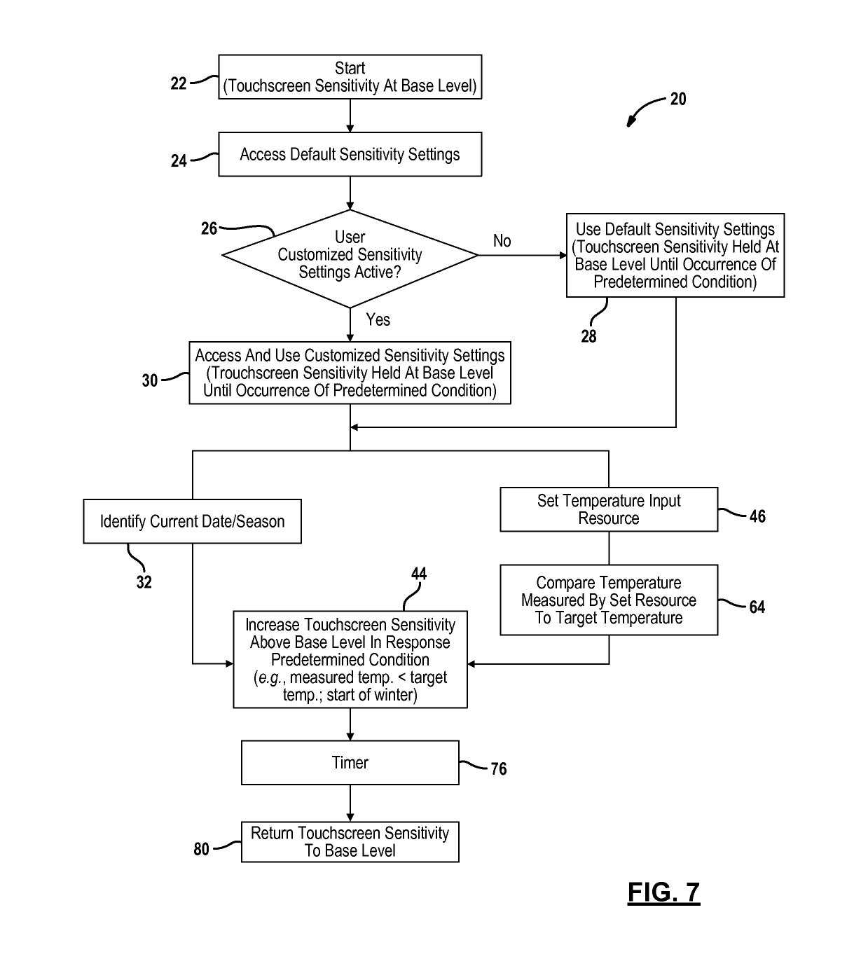

With reference to FIG. 7, the method 20 can be further modified to eliminate block 78, at which the controller 12 determines whether the measured cabin temperature is equal to or greater than the target temperature. The controller 12 thus proceeds from block 44 directly to the timer block 76. After the predetermined period of time measured at timer block 76 expires, the controller 12 proceeds to block 80 and returns touchscreen sensitivity to the base level.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for adjusting input sensitivity of a touchscreen comprising:
providing input sensitivity of the touchscreen at a base level;
increasing input sensitivity of the touchscreen above the base level in response to detection of at least one predetermined condition; and
returning input sensitivity of the touchscreen to the base level when atmospheric temperature proximate to the touchscreen is equal to or greater than a first target temperature.

2. The method of claim 1, further comprising including the touchscreen with a vehicle navigation device.

3. The method of claim 1, further comprising providing the touchscreen with a capacitance switch.

4. The method of claim 1, wherein:
input sensitivity of the touchscreen above the base level is sufficient for the touchscreen to detect contact with the touchscreen by a finger covered with a glove; and
input sensitivity of the touchscreen at the base level is generally insufficient for the touchscreen to detect contact with the touchscreen by a finger covered with a glove.

5. The method of claim 1, wherein the at least one predetermined condition includes at least one of the following: temperature inside a passenger cabin is below the first target temperature; temperature outside the passenger cabin is below a second target temperature; or current date is within a target date range.

6. The method of claim 5, wherein the target date range corresponds to seasonal period when average daily temperatures are below the second target temperature.

7. The method of claim 1, wherein:
the at least one predetermined condition and the first target temperature are customized by a user of the touchscreen; and
the first target temperature is equal to a user preferred cabin temperature of a motor vehicle.

8. The method of claim 1, wherein the at least one predetermined condition includes temperature outside a passenger cabin including the touchscreen falling below a second target temperature, the temperature outside the passenger cabin detected using one of a satellite weather service or a personal data device.

9. The method of claim 1, wherein the at least one predetermined condition includes temperature inside a passenger cabin including the touchscreen falling below the first target temperature, the temperature inside the passenger cabin measured using a vehicle heating and air conditioning system.

10. The method of claim 1, wherein the atmospheric temperature proximate to the touchscreen is a vehicle cabin temperature.

11. The method of claim 1, wherein atmospheric temperature proximate to the touchscreen is determined to have increased to at least the first target temperature after expiration of a predetermined period of time measured with a timer.

12. The method of claim 11, wherein after expiration of the predetermined period of time, the temperature proximate to the touchscreen is compared to the first target temperature, if the temperature proximate to the touchscreen is less than the first target temperature then sensitivity of the touchscreen is maintained above the base level for the predetermined period of time again, if the temperature proximate to the touchscreen is equal to or greater than the first target temperature then sensitivity of the touchscreen returns to the base level.

13. A method for adjusting input sensitivity of a touchscreen comprising:
providing input sensitivity of the touchscreen at a base level;
increasing input sensitivity of the touchscreen above the base level in response to detection of at least one predetermined condition;
maintaining input sensitivity of the touchscreen above the base level for a predetermined amount of time measured by a timer;
comparing atmospheric temperature proximate to the touchscreen to a first target temperature after expiration of the predetermined amount of time;
returning input sensitivity of the touchscreen to the base level when atmospheric temperature proximate to the touchscreen is equal to or greater than the first target temperature; and
maintaining input sensitivity of the touchscreen above the base level when atmospheric temperature proximate to the touchscreen is below the first target temperature.

14. The method of claim 13, further comprising including the touchscreen with a vehicle navigation device.

15. The method of claim 13, wherein:
input sensitivity of the touchscreen above the base level is sufficient for the touchscreen to detect contact with the touchscreen by a gloved finger;
and input sensitivity of the touchscreen at the base level is generally insufficient for the touchscreen to detect contact with the touchscreen by a gloved finger.

16. The method of claim 13, wherein the at least one predetermined condition includes at least one of the following: temperature inside a passenger cabin is below the first target temperature; temperature outside the passenger cabin is below a second target temperature; or current date is within a target date range.

17. The method of claim 13, wherein the first target temperature is set by a user of the touchscreen and atmospheric temperature proximate to the touchscreen is a vehicle cabin temperature.

18. A vehicle navigation touchscreen assembly comprising:
a touchscreen configured to receive input commands from a user of a vehicle navigation device; and
a controller in communication with the touchscreen, the controller configured to adjust input sensitivity of the touchscreen, the controller in communication with a vehicle cabin temperature input resource configured to measure temperature inside a vehicle cabin, and the controller in communication with an external temperature input resource configured to measure temperature outside the vehicle cabin;
wherein:
the controller is configured to increase input sensitivity of the touchscreen above a base level in response to occurrence of at least one predetermined condition; and
the controller is configured to set input sensitivity of the touchscreen at the base level when temperature in the vehicle cabin is greater than or equal to a first target temperature.

19. The vehicle navigation touchscreen of claim 18, further comprising an vehicle navigation system including the touchscreen.

20. The vehicle navigation touchscreen of claim 18, wherein the at least one predetermined condition includes at least one of the following:
temperature inside the cabin is below the first target temperature; temperature outside the cabin is below a second target temperature; or current date is within a target date range.
